(19) United States
(12) Patent Application Publication
(10) Pub. No.: US 2024/0429498 A1
(43) Pub. Date: Dec. 26, 2024

(54) POWER STORAGE MODULE

(71) Applicant: TOYOTA JIDOSHA KABUSHIKI KAISHA, Toyota-shi (JP)

(72) Inventors: Yosuke SHIMURA, Toyota-shi (JP); Yoshiro OBAYASHI, Toyota-shi (JP); Atsushi YAMANAKA, Nagoya-shi (JP); Masashi CHIHARA, Nagoya-shi (JP); Kazuki SUGIE, Miyoshi-shi (JP); Kosuke YONEKAWA, Nisshin-shi (JP); Yasuhiro HIRAO, Toyota-shi (JP)

(73) Assignee: TOYOTA JIDOSHA KABUSHIKI KAISHA, Toyota-shi (JP)

(21) Appl. No.: 18/674,261

(22) Filed: May 24, 2024

(30) Foreign Application Priority Data
Jun. 23, 2023 (JP) 2023-103354

(51) Int. Cl. H01M 50/126; H01M 50/112; H01M 50/121; H01M 50/131; H01M 50/16; H01M 50/164

(52) U.S. Cl. CPC H01M 50/126; H01M 50/112; H01M 50/121; H01M 50/131; H01M 50/16; H01M 50/164

(57) ABSTRACT

A power storage module includes a plurality of electrode assemblies and a case. The case includes a bottom portion, a peripheral sidewall portion, a lid portion, and at least one partition portion. The bottom portion is located at one side of the electrode assemblies in a second direction. The partition portion is formed integrally with the bottom portion and the peripheral sidewall portion. The partition portion is located between the electrode assemblies adjacent to each other. Each of the bottom portion, the peripheral sidewall portion, and the lid portion includes a resin layer and a barrier layer. The resin layer is made from a resin composition. The barrier layer is superposed on the resin layer. The barrier layer has a lower moisture permeability than that of the resin layer.

### CROSS REFERENCE TO RELATED APPLICATIONS

This nonprovisional application is based on Japanese Patent Application No. 2023-103354 filed on Jun. 23, 2023 with the Japan Patent Office, the entire contents of which are hereby incorporated by reference.

### BACKGROUND

### Field

The present disclosure relates to a power storage module.

### Description of the Background Art

In the housing of the battery case disclosed in Japanese Patent Laying-Open No. No. 2019-106372, a lower wall and a plurality of (for example, three, four, or more) sidewalls are integrated to form a space inside, an open surface opposed to the lower wall is provided, and one or more (for example, two, three, four, five, or more) partitions are provided in the space. Thereby, the housing includes a plurality of battery compartments separated by one or more partitions disposed in the space. Each battery compartment can accommodate an electrode assembly. The battery case further includes a lid portion for closing the open surface of the housing. The housing is a molded article of a composition including a base polymer and an inorganic hygroscopic agent dispersed in the base polymer.

### SUMMARY

Japanese Patent Laying-Open No. 2019-106372 discloses a case made of resin capable of accommodating a plurality of electrode assemblies. However, since the case is made of resin, the moisture permeability is higher than that of the case made of metal. There is room for further improvement in reducing the moisture permeability of the case.

The present disclosure is given in view of the above problem, and it is an object of the present disclosure to provide a power storage module in which the moisture permeability of a resin case is reduced.

A power storage module according to the present disclosure includes a plurality of electrode assemblies and a case. The plurality of electrode assemblies are arranged in a first direction. The case houses the plurality of electrode assemblies. The case includes a bottom portion, a peripheral sidewall portion, a lid portion, and at least one partition portion. The bottom portion is located at one side of the plurality of electrode assemblies in a second direction. The second direction is orthogonal to the first direction. The peripheral sidewall portion extends upright in the second direction from an outer peripheral edge of the bottom portion. The peripheral sidewall portion surrounds the plurality of electrode assemblies. The lid portion is located at the other side of the plurality of electrode assemblies in the second direction. The partition portion is integrally formed with the bottom portion and the peripheral sidewall portion. The partition portion is located between the electrode assemblies adjacent to each other. Each of the bottom portion, the peripheral sidewall portion, and the lid portion includes a resin layer and a barrier layer. The resin layer is made from a resin composition. The barrier layer is superposed on the resin layer. The barrier layer has a lower moisture permeability than that of the resin layer.

According to the above configuration, the barrier layer is disposed, together with the resin layer, on each of the bottom portion, the peripheral sidewall portion, and the lid portion. Thus, in the power storage module, the moisture permeability of the case can be reduced even when the case is mainly formed of the resin layer. Accordingly, a power storage module in which the moisture permeability of the resin case is reduced is provided.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view showing a power storage module according to a first embodiment.

FIG. 2 is a partially exploded perspective view of the power storage module according to the first embodiment.

FIG. 3 is a cross-sectional view of the power storage module of FIG. 1 taken along a line III-III.

FIG. 4 is a cross-sectional view of the power storage module of FIG. 1 taken along a line IV-IV.

FIG. 5 is a cross-sectional view of an electrode assembly of the power storage module of FIG. 1 taken along a line V-V.

FIGS. 6A and 6B are cross-sectional views of a power storage module according to a second embodiment.

FIG. 7 is a cross-sectional view of a power storage module according to a third embodiment.

### DESCRIPTION OF THE PREFERRED EMBODIMENTS

Embodiments of the present disclosure will be described with reference to the drawings. In the drawings referred to below, the same or corresponding members are denoted by the same reference numerals.

### First Embodiment

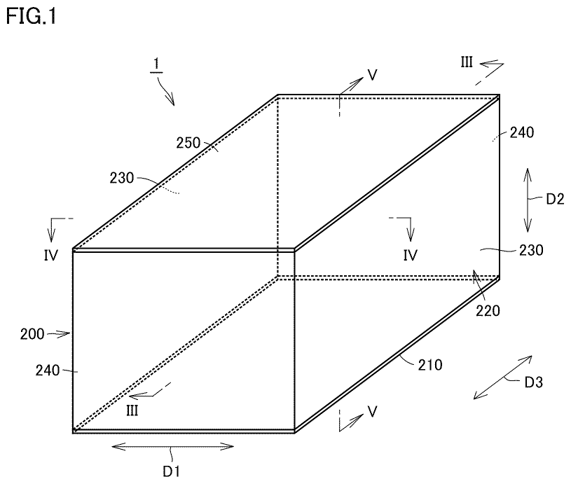

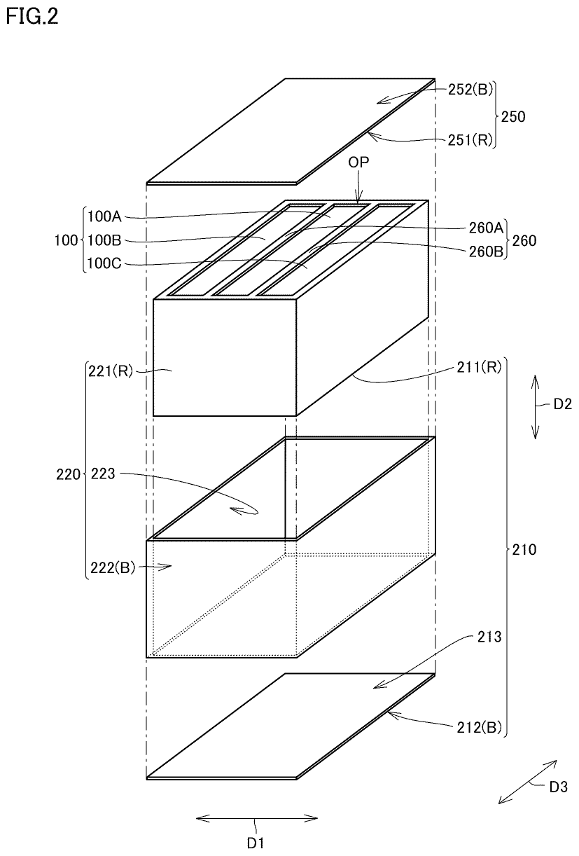

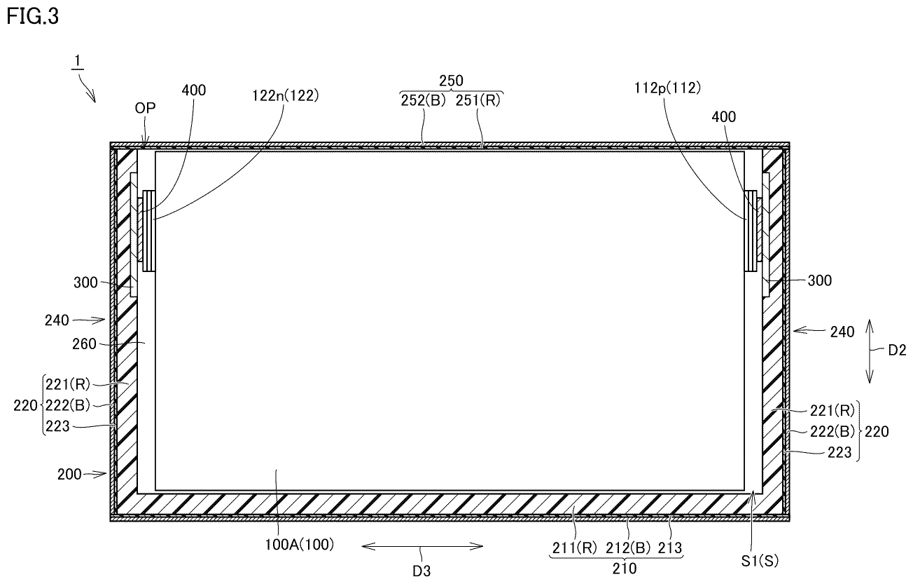

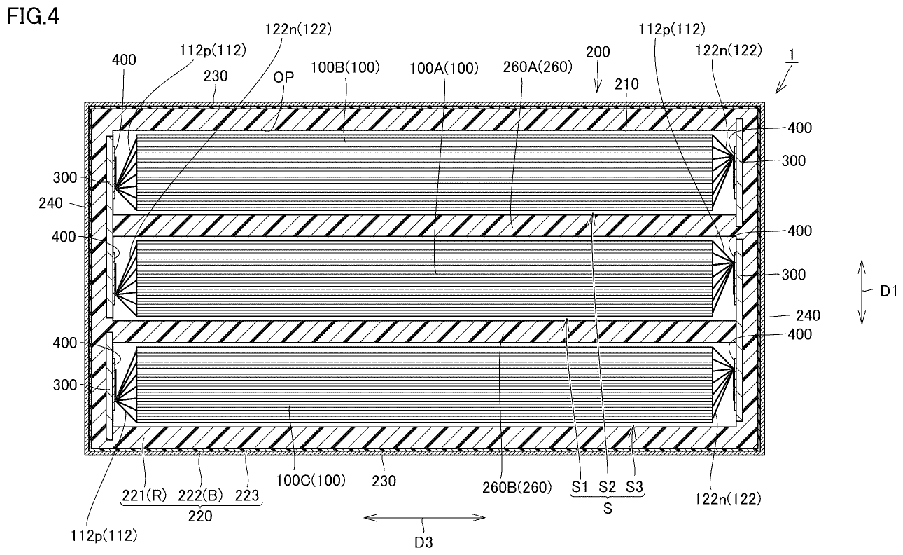

FIG. 1 is a perspective view showing a power storage module according to a first embodiment. FIG. 2 is a partially exploded perspective view of the power storage module according to the first embodiment. FIG. 3 is a cross-sectional view of the power storage module of FIG. 1 taken along a line III-III. FIG. 4 is a cross-sectional view of the power storage module of FIG. 1 taken along a line IV-IV.

As shown in FIGS. 1 to 4, a power storage module 1 according to a first embodiment of the present disclosure includes a plurality of electrode assemblies 100 and a case 200. The plurality of electrode assemblies 100 are arranged in the first direction D1. The second direction D2 described later is orthogonal to the first direction D1, and the third direction D3 is orthogonal to both the first direction D1 and the second direction D2. The case 200 houses a plurality of electrode assemblies 100.

In this embodiment, the plurality of electrode assemblies 100 include a first electrode assembly 100A, a second electrode assembly 100B, and a third electrode assembly 100C. The third electrode assembly 100C is located opposite to the second electrode assembly 100B when viewed from the first electrode assembly 100A. The plurality of electrode assemblies 100 may include four or more electrode assemblies.

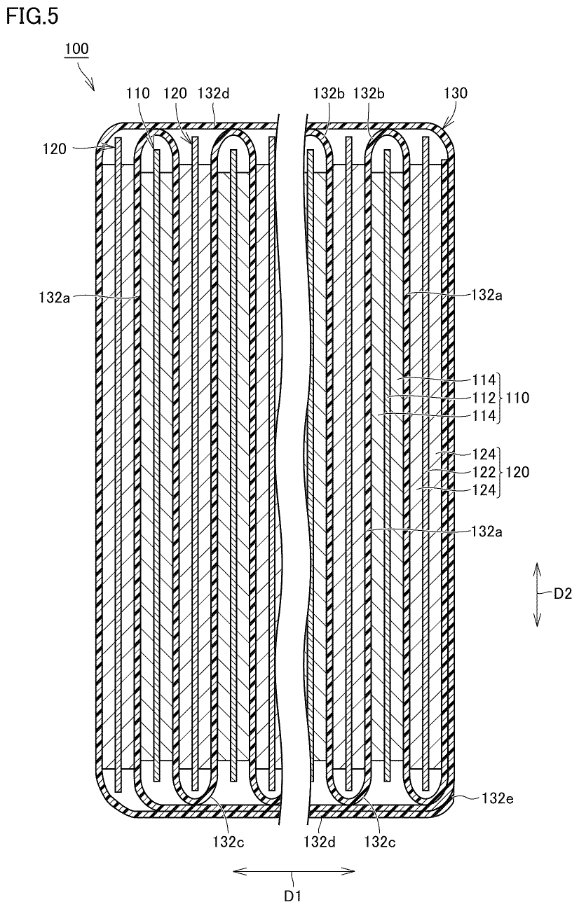

FIG. 5 is a cross-sectional view of the electrode assembly of the power storage module of FIG. 1 taken along a line V-V. As shown in FIG. 5, each of the plurality of electrode assemblies 100 includes a plurality of electrodes 110 and 120 and a separator 130. In this embodiment, the electrode assembly 100 is an electrode assembly for a secondary battery such as a lithium-ion secondary battery.

As shown in FIG. 5, the plurality of electrodes 110 and 120 are arranged in the first direction D1. The plurality of electrodes 110 and 120 have a plurality of positive electrodes 110 and a plurality of negative electrodes 120.

Each positive electrode 110 is formed in a rectangular shape elongated in the third direction D3. Each positive electrode 110 includes a positive electrode current collector foil 112 and a positive electrode active material layer 114 provided on both surfaces of the positive electrode current collector foil 112. The positive electrode current collector foil 112 has a positive electrode tab 112p (see FIGS. 3 and 4) in which the positive electrode active material layer 114 is not provided. The positive electrode tab 112p protrudes toward one side in the third direction D3.

Each negative electrode 120 is formed in a rectangular shape elongated in the third direction D3. Each negative electrode 120 includes a negative electrode current collector foil 122 and a negative electrode active material layer 124 provided on both surfaces of the negative electrode current collector foil 122. The negative electrode current collector foil 122 has a negative electrode tab 122n (see FIGS. 3 and 4) in which the negative electrode active material layer 124 is not provided. The negative electrode tab 122n protrudes toward the other side in the third direction D3.

The separator 130 insulates the positive electrode 110 from the negative electrode 120. The separator 130 is made from an insulating material, and has minute voids that allow penetration of ions. As shown in FIG. 5, the separator 130 is folded.

The separator 130 has a rectangular shape before being folded. The separator 130 is folded between the electrodes 110 and 120. The separator 130 includes a plurality of intervening portions 132a, a plurality of upper folded portions 132b, a plurality of lower folded portions 132c, and an outermost covering portion 132d.

Each intervening portion 132a is interposed between a pair of electrodes 110 and 120 adjacent to each other in one direction. That is, each intervening portion 132a has a function of insulating the positive electrode 110 and the negative electrode 120. Each intervening portion 132a is formed of a rectangular region.

The upper folded portions 132b connect an upper end portion of one of the plurality of intervening portions 132a and an upper end portion of the intervening portion 132a adjacent to the one intervening portion 132a on one side of the plurality of intervening portions 132a in one direction. In the present embodiment, the upper folded portion 132b is disposed above the positive electrode 110.

Each lower folded portion 132c connects a lower end portion of the one intervening portion of the plurality of intervening portions 132a and a lower end portion of the intervening portion 132a adjacent to the one intervening portion on the other side in one direction of the plurality of intervening portions 132a. In the present embodiment, the lower folded portion 132c is disposed below the negative electrode 120. In other words, the negative electrode 120 is disposed on the lower folded portion 132c.

The outermost covering portions 132d collectively cover the upper folded portions 132b and the lower folded portions 132c. More specifically, the outermost covering portion 132d covers all of the electrodes 110 and 120, all of the intervening portions 132a, all of the upper folded portions 132b, and all of the lower folded portions 132c while winding around the central axis parallel to the third direction D3. The terminal end 132e of the outermost covering portion 132d is set so as not to overlap the positive electrode active material layer 114 and the negative electrode active material layer 124 in one direction. In the present embodiment, the terminal end 132e of the outermost covering portion 132d is provided below each of the electrodes 110 and 120. The peripheral surfaces and bottom surfaces of the plurality of electrodes 110 and 120 and the separator 130 may or may not be covered with an insulating film. The peripheral surfaces and bottom surfaces of the plurality of electrodes 110, 120 and the separator 130 may be in direct contact with the case 200.

As shown in FIGS. 1 to 4, the case 200 includes a bottom portion 210, a peripheral sidewall portion 220, a lid portion 250, and at least one partition portion 260. Each of the bottom portion 210, the peripheral sidewall portion 220, and the lid portion 250 includes a resin layer R and a barrier layer B.

The resin layer R has electrical insulation property. The resin layer R is made from a resin composition. The barrier layer B is superposed on the resin layer R. The barrier layer B has a lower moisture permeability than that of the resin layer R. The details of the resin layer R and the barrier layer B will be described later.

The bottom portion 210 is positioned on one side of the plurality of electrode assemblies 100 in the second direction D2. The bottom portion 210 extends along the first direction D1 and the third direction D3. When viewed from the second direction D2, the bottom portion 210 has a rectangular outer shape.

The bottom portion 210 includes a first bottom resin layer 211 made from a first resin composition as a resin layer R, a bottom barrier layer 212 as a barrier layer B, and a second bottom resin layer 213 made from a third resin composition. The second resin composition will be described later.

The bottom barrier layer 212 is disposed outside the case 200 when viewed from the first bottom resin layer 211. The bottom barrier layer 212 is disposed so as to overlap the entire first bottom resin layer 211 when viewed from the second direction D2. The bottom barrier layer 212 is joined to the first bottom resin layer 211 with the second bottom resin layer 213 interposed therebetween.

The second bottom resin layer 213 is joined to the first bottom resin layer 211 by thermal welding. The entire contact surfaces of the second bottom resin layer 213 and the first bottom resin layer 211 may be welded, or a part of the contact surfaces of the second bottom resin layer 213 and the first bottom resin layer 211 may be welded. The second bottom resin layer 213 may be welded only in the vicinity of the outer peripheral edge portion of the first bottom resin layer 211 when viewed from the second direction D2.

The peripheral sidewall portion 220 extends upright from the outer peripheral edge of the bottom portion 210 in the second direction D2. The peripheral sidewall portion 220 surrounds the plurality of electrode assemblies 100. The peripheral sidewall portion 220 forms an opening OP that opens in the direction opposite to the bottom portion 210.

The peripheral sidewall portion 220 includes a pair of first wall portions 230 and a pair of second wall portions 240. The first wall portions 230 of the pair are arranged in the first direction D1. The pair of first wall portions 230 extends along the third direction D3. The second wall portions 240 of the pair are arranged in the third direction D3. The pair of second wall portions 240 extends along the first direction D1.

The peripheral sidewall portion 220 includes a first peripheral resin layer 221 made from the first resin composition as a resin layer R, a peripheral barrier layer 222 as a barrier layer B, and a second peripheral resin layer 223 made from the second resin composition.

The peripheral barrier layer 222 is disposed outside the case 200 when viewed from the first peripheral resin layer 221. The peripheral barrier layer 222 is disposed so as to overlap the entire first peripheral resin layer 221 when viewed from the first direction D1 and the third direction D3. The peripheral barrier layer 222 is joined to the first peripheral resin layer 221 with the second peripheral resin layer 223 interposed therebetween.

The second peripheral resin layer 223 is joined to the first peripheral resin layer 221 by thermal welding. The second peripheral resin layer 223 and the first peripheral resin layer 221 may entirely be welded to each other, or respective contact surfaces of the second peripheral resin layer 223 and the first peripheral resin layer 221 may partially be welded. For example, when viewed from the first direction D1, the second peripheral resin layer 223 and the first peripheral resin layer 221 may be thermally welded to each other only in the vicinity of the peripheral edge portion of each of the pair of first wall portions 230. When viewed from the third direction D3, the second peripheral resin layer 223 and the first peripheral resin layer 221 may be thermally welded to each other only in the vicinity of the peripheral edge portion of each of the pair of second wall portions 240.

The lid portion 250 is positioned on the other side of the plurality of electrode assemblies 100 in the second direction D2. The lid portion 250 closes the opening OP. The lid portion 250 has, for example, a film-like outer shape.

The lid portion 250 includes a lid resin layer 251 made from a fourth resin composition as a resin layer R, and a lid barrier layer 252 as a barrier layer B.

The lid resin layer 251 is joined to the first peripheral resin layer 221 by thermal welding or the like. The lid barrier layer 252 is disposed outside the case 200 when viewed from the lid resin layer 251. The lid barrier layer 252 is joined to the first peripheral resin layer 221 with the lid resin layer 251 interposed therebetween.

The partition portion 260 is positioned between the electrode assemblies 100 adjacent to each other. The partition portion 260 defines the accommodation space S of the case 200. The case 200 according to the present embodiment includes a plurality of partition portions 260. The plurality of partition portions 260 include a first partition portion 260A and a second partition portion 260B. The plurality of partition portions 260 may include three or more partition portions.

A first compartment S1 and a second compartment S2 are formed by the first partition portion 260A in the accommodation space S of the case 200. Further, in the accommodation space S, the first compartment S1 and a third compartment S3 are formed by the second partition portion 260B. The third compartment S3 is positioned opposite to the second compartment S2 when viewed from the first compartment S1.

The first electrode assembly 100A is accommodated in the first compartment S1. The second electrode assembly 100B is accommodated in the second compartment S2. The third electrode assembly 100C is accommodated in the third compartment. An electrolyte solution is injected into the accommodation space S (the first compartment S1, the second compartment S2, and the third compartment S3). The electrolyte solution is not shown. The method of injecting the electrolyte solution is not particularly limited. The electrolyte solution may be injected from the opening OP before the opening OP is closed by the lid portion 250.

The partition portion 260 is made from the first resin composition. The partition portion 260 is formed integrally with the bottom portion 210 and the peripheral sidewall portion 220. Specifically, the first bottom resin layer 211, the first peripheral resin layer 221, and the partition portion 260 are integrally formed with each other. The partition portion 260 and the lid resin layer 251 may or may not be joined to each other by thermal welding.

In the present embodiment, examples of the above-described “integrally formed” method include a method in which molding and joining of each component are performed simultaneously in one step by a well-known method such as injection molding, and a method in which a plurality of components are separately formed and then joined to each other by a well-known joining method such as welding, or adhesion.

Here, the first resin composition that may form the first bottom resin layer 211, the first peripheral resin layer 221, and the partition portion 260 in the present embodiment will be described.

The first resin composition may contain, as a base polymer, polycarbonate, polyethylene, polypropylene, polyvinyl, polyamide, polyester, polyphenylene sulfide (PPS), polyphenylene ether, polystyrene, polycyclic olefin copolymer, acrylonitrile-butadiene-styrene copolymer, liquid crystal polymer (LCP), fluororesin, a mixture thereof, an alloy thereof, or a copolymer thereof. The base polymer is not limited to them.

The first resin composition may contain, as a base polymer, polyolefin, liquid crystal polymer, or fluororesin. The polyolefin may include High-Density Polyethylene (HDPE). The High-Density Polyethylene, liquid crystal polymer, or fluororesin has a relatively low water vapor permeability. Therefore, the case 200 mainly made from a resin composition containing these components has relatively high moisture permeability resistance.

The liquid crystal polymer may include structural units derived from an oligomer of hydroxybenzoic acid. The liquid crystal polymer may further contain two or more kinds selected from the group consisting of HNA (2,6-hydroxynaphthoic acid), TPA (terephthalic acid), IPA (isophthalic acid), HQ (hydroquinone), BP (biphenol), PET (polyethylene terephthalate) and PEN (polyethylene naphthalate), in addition to the oligomer of hydroxybenzoic acid, and may be copolymerized with the oligomer of hydroxybenzoic acid (HBA).

The fluororesin may be polytetrafluoroethylene (PTFE), polyvinylidene difluoride (PVDF), polychlorotrifluoroethylene (PCTFE), or a mixture thereof, or a copolymer thereof. The fluororesin is hydrophobic. Thus, relative to the total weight of the resin composition, the resin composition may contain, for example, about 20% by weight or less, about 15% by weight or less, about 10% by weight or less, about 3% by weight to about 10% by weight, about 5% by weight to about 10% by weight of fluororesin. When the content of the fluororesin falls within the above ranges, it is considered that the molded article made from the first resin composition has an effect of blocking moisture from the surface of the molded article in contact with the outside air.

The first resin composition may further contain an inorganic hygroscopic agent or graphite from the viewpoint of suppressing water vapor permeability. The resin composition may further contain a substance known as an existing moisture barrier substance in addition to graphite.

In this embodiment, the bottom barrier layer 212 and the second bottom resin layer 213, the peripheral barrier layer 222 and the second peripheral resin layer 223, and the lid resin layer 251 and the lid barrier layer 252 are formed of a so-called laminate film.

The bottom barrier layer 212, the peripheral barrier layer 222, and the lid barrier layer 252 are made of a metal such as aluminum. In this embodiment, the thickness of each of the bottom barrier layer 212, the peripheral barrier layer 222, and the lid barrier layer 252 is preferably 100 μm or less from the viewpoint of moldability.

The thicknesses of the second bottom resin layer 213, the second peripheral resin layer 223, and the lid resin layer 251 are all smaller than the thicknesses of the first bottom resin layer 211 and the first peripheral resin layer 221. The thicknesses of the second bottom resin layer 213, the second peripheral resin layer 223, and the lid resin layer 251 may be, for example, 50 μm or less.

The specific composition of the third resin composition constituting the second bottom resin layer 213, the second resin composition constituting the second peripheral resin layer 223, and the fourth resin composition constituting the lid resin layer 251 is not particularly limited. The base polymer contained in the second resin composition, the third resin composition, and the fourth resin composition is preferably the same as the base polymer contained in the first resin composition. This facilitates thermal welding of the second bottom resin layer 213, the second peripheral resin layer 223, and the lid resin layer 251 to the other resin layers of the case 200 made from the first resin composition. From the viewpoint of making thermal welding easier, it is also preferred that the base polymer of these compositions is polyethylene or polypropylene.

The power storage module 1 according to the first embodiment of the present disclosure includes a plurality of conductive members 300. Each conductive member 300 is disposed at a side of the plurality of electrode assemblies 100 in the third direction D3. Each conductive member 300 may electrically connect the electrode assemblies 100 adjacent to each other in the first direction D1. The plurality of conductive members 300 are provided so as to be exposed to the accommodation space S. The plurality of conductive members 300 are partially embedded in the case 200. The conductive members 300 are disposed so as not to contact the barrier layers. The conductive member 300 may be exposed to the outside of the case 200.

The power storage module 1 according to the first embodiment of the present disclosure further includes a plurality of current collecting members 400. The plurality of current collecting members 400 are positioned on both sides of each of the plurality of electrode assemblies 100 in the third direction D3. Each current collecting member 400 is joined to the positive electrode tab 112p or the negative electrode tab 122n by welding. Each current collecting member 400 is further joined to the conductive member 300. Thus, the conductive member 300 and the electrode assembly 100 are electrically connected to each other. The positive electrode tab 112p or the negative electrode tab 122n may be directly connected to the conductive member 300 by welding.

As described above, in the power storage module 1 according to the first embodiment of the present disclosure, each of the bottom portion 210, the peripheral sidewall portion 220, and the lid portion 250 includes the resin layer R and the barrier layer B. The resin layer R is made from a resin composition. The barrier layer B is superposed on the resin layer R. The barrier layer B has a lower moisture permeability than that of the resin layer R.

According to the above configuration, the barrier layer B is disposed on each of the bottom portion 210, the peripheral sidewall portion 220, and the lid portion 250 together with the resin layer R. Thus, in the power storage module 1, moisture permeability of the case 200 can be reduced even when the case 200 is mainly formed of the resin layer R. As a result, the power storage module 1 in which the moisture permeability of the resin case is reduced is provided.

Further, in the first embodiment of the present disclosure, the bottom portion 210 includes a first bottom resin layer 211 made from the first resin composition as the resin layer R, and a bottom barrier layer 212 as the barrier layer B. The peripheral sidewall portion 220 includes a first peripheral resin layer 221 made from the first resin composition as a resin layer R, and a peripheral barrier layer 222 as a barrier layer B. The partition portion 260 is made from the first resin composition. The first bottom resin layer 211, the first peripheral resin layer 221, and the partition portion 260 are formed integrally with each other.

According to the above configuration, since the first bottom resin layer 211, the first peripheral resin layer 221, and the partition portion 260 are all made from the first resin composition and integrally formed with each other, the manufacturing cost of the case 200 can be reduced.

Further, in the first embodiment of the present disclosure, the peripheral sidewall portion 220 further includes a second peripheral resin layer 223 made from a second resin composition. The peripheral barrier layer 222 is located outward of the case 200, with respect to the first peripheral resin layer 221. The peripheral barrier layer 222 is joined to the first peripheral resin layer 221 with the second peripheral resin layer 223 interposed therebetween.

According to the above configuration, the peripheral barrier layer 222 can be easily disposed on the peripheral sidewall portion 220. For example, by welding a laminate film including a resin sheet and a barrier sheet from the outside of the first peripheral resin layer 221, the resin sheet and the barrier sheet can be disposed as the second peripheral resin layer 223 and the peripheral barrier layer 222.

Further, in the first embodiment of the present disclosure, the bottom portion 210 further includes a second bottom resin layer 213 made from a third resin composition. The bottom barrier layer 212 is located outward of the case 200, with respect to the first bottom resin layer 211. The bottom barrier layer 212 is joined to the first bottom resin layer 211 with the second bottom resin layer 213 interposed therebetween.

According to the above configuration, the bottom barrier layer 212 can be easily disposed on the bottom portion 210. For example, by welding a laminate film including a resin sheet and a barrier sheet from the outside of the first bottom resin layer 211, the resin sheet and the barrier sheet can be disposed as the second bottom resin layer 213 and the bottom barrier layer 212.

### Second Embodiment

Hereinafter, a power storage module according to a second embodiment of the present disclosure will be described. In the power storage module according to the second embodiment of the present disclosure, the configuration of the peripheral sidewall portion is mainly different from that of the power storage module 1 according to the first embodiment of the present disclosure. Therefore, in the power storage module according to the second embodiment of the present disclosure, description of the same configuration and effect as in the first embodiment will not be repeated.

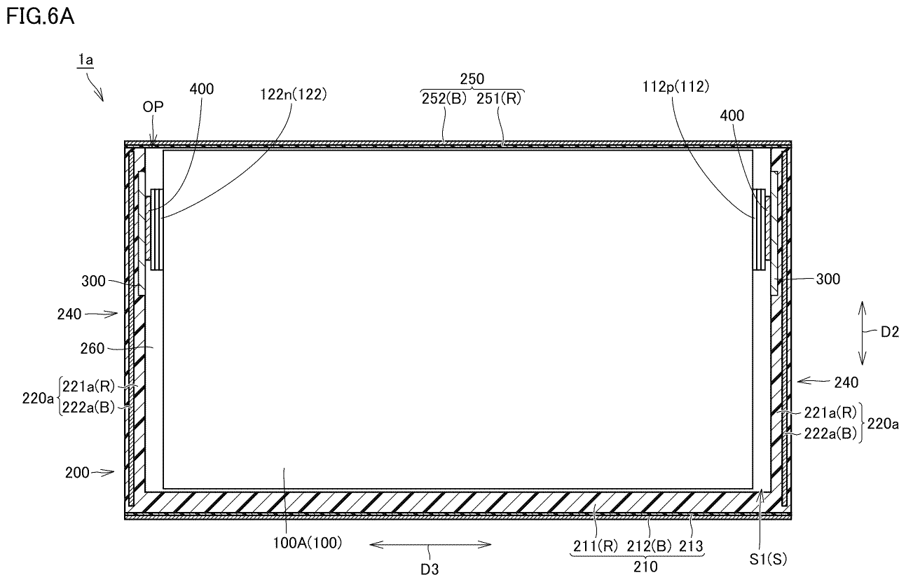

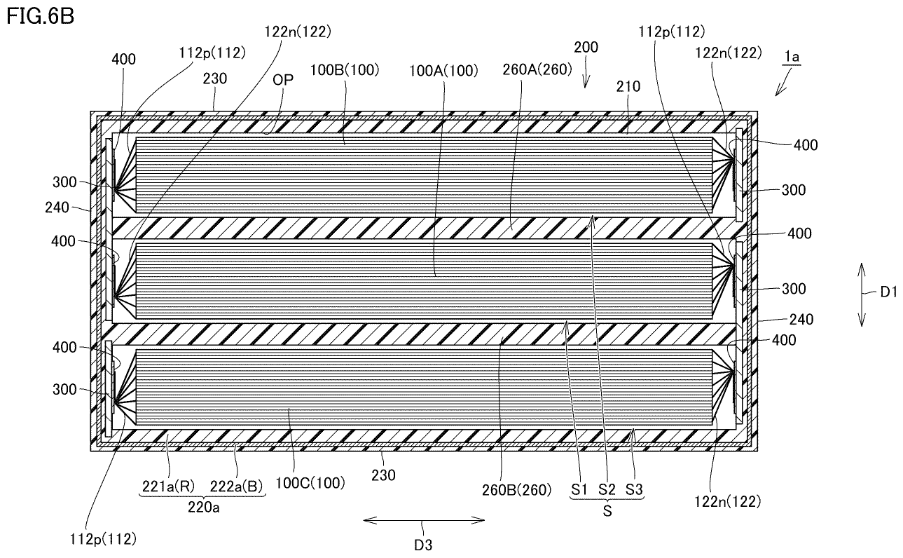

FIG. 6A is a cross-sectional view of the power storage module according to the second embodiment as viewed from one direction. FIG. 6B is a cross-sectional view of the power storage module according to the second embodiment as viewed from another direction. FIGS. 6A and 6B show the power storage module in a cross-sectional view similar to the cross-section of the power storage module 1 according to the first embodiment shown in FIGS. 3 and 4, respectively.

As shown in FIGS. 6A and 6B, in the power storage module la according to the second embodiment of the present disclosure, the peripheral barrier layer 222a is embedded in the first peripheral resin layer 221a so as not to be exposed from the peripheral sidewall portion 220a. This makes it easy to ensure electrical insulation on the outer surface of the peripheral sidewall portion 220a.

The first peripheral resin layer 221a is formed, for example, by injection molding the second resin composition so as to surround the peripheral barrier layer 222a. In this embodiment, the peripheral barrier layer 222a may be a plate-like member.

### Third Embodiment

Hereinafter, a power storage module according to a third embodiment of the present disclosure will be described. In the power storage module according to the third embodiment of the present disclosure, the configuration of the bottom portion is mainly different from that of the power storage module la according to the second embodiment of the present disclosure. Therefore, in the power storage module according to the third embodiment of the present disclosure, description of the same configuration and effect as those of the second embodiment will not be repeated.

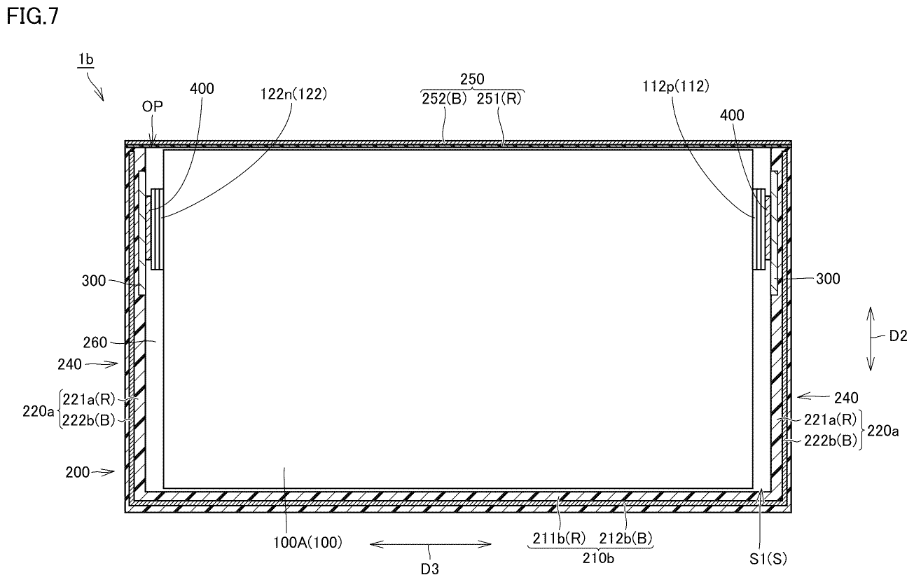

FIG. 7 is a cross-sectional view of a power storage module according to a third embodiment. FIG. 7 shows a power storage module in a cross-sectional view similar to that of the power storage module la according to the second embodiment shown in FIG. 6A.

As shown in FIG. 7, in the power storage module 1b according to the third embodiment of the present disclosure, the bottom barrier layer 212b is embedded in the first bottom resin layer 211b so as not to be exposed from the bottom portion 210b. This makes it easy to ensure electrical insulation on the outer surface of the bottom portion 210b.

The first bottom resin layer 211b is formed, for example, by injection molding a third resin composition so as to surround the bottom barrier layer 212b. In this embodiment, the bottom barrier layer 212b may be a plate-like member. Further, the peripheral barrier layer 222b may extend upright from the outer peripheral edge of the bottom barrier layer 212b when viewed from the second direction D2 so as to stand upright.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage module comprising:
a plurality of electrode assemblies arranged in a first direction; and
a case housing the plurality of electrode assemblies, wherein
the case includes:
a bottom portion located at one side of the plurality of electrode assemblies in a second direction orthogonal to the first direction;
a peripheral sidewall portion extending upright in the second direction from an outer peripheral edge of the bottom portion, and surrounding the plurality of electrode assemblies;
a lid portion located at the other side of the plurality of electrode assemblies in the second direction; and
at least one partition portion formed integrally with the bottom portion and the peripheral sidewall portion, and located between the electrode assemblies adjacent to each other, and
each of the bottom portion, the peripheral sidewall portion, and the lid portion includes a resin layer made from a resin composition, and a barrier layer superposed on the resin layer and having a lower moisture permeability than that of the resin layer.

2. The power storage module according to claim 1, wherein
the bottom portion includes: a first bottom resin layer made from a first resin composition, as the resin layer; and a bottom barrier layer as the barrier layer,
the peripheral sidewall portion includes: a first peripheral resin layer made from the first resin composition, as the resin layer; and a peripheral barrier layer as the barrier layer,
the partition portion is made from the first resin composition, and
the first bottom resin layer, the first peripheral resin layer, and the partition portion are integrally formed together.

3. The power storage module according to claim 2, wherein
the peripheral sidewall portion further includes a second peripheral resin layer made from a second resin composition,
the peripheral barrier layer is located outward of the case, with respect to the first peripheral resin layer, and
the peripheral barrier layer is joined to the first peripheral resin layer with the second peripheral resin layer interposed between the peripheral barrier layer and the first peripheral resin layer.

4. The power storage module according to claim 2, wherein the peripheral barrier layer is embedded in the first peripheral resin layer, so as not to be exposed from the peripheral sidewall portion.

5. The power storage module according to claim 2, wherein
the bottom portion further includes a second bottom resin layer made from a third resin composition,
the bottom barrier layer is located outward of the case, with respect to the first bottom resin layer, and
the bottom barrier layer is joined to the first bottom resin layer with the second bottom resin layer interposed between the bottom barrier layer and the first bottom resin layer.

6. The power storage module according to claim 3, wherein
the bottom portion further includes a second bottom resin layer made from a third resin composition,
the bottom barrier layer is located outward of the case, with respect to the first bottom resin layer, and
the bottom barrier layer is joined to the first bottom resin layer with the second bottom resin layer interposed between the bottom barrier layer and the first bottom resin layer.

7. The power storage module according to claim 4, wherein
the bottom portion further includes a second bottom resin layer made from a third resin composition,
the bottom barrier layer is located outward of the case, with respect to the first bottom resin layer, and
the bottom barrier layer is joined to the first bottom resin layer with the second bottom resin layer interposed between the bottom barrier layer and the first bottom resin layer.
